(19) United States
(12) Patent Application Publication
(10) Pub. No.: US 2011/0064360 A1
(43) Pub. Date: Mar. 17, 2011

(54) OPTICAL SEMICONDUCTOR ELEMENT AND METHOD FOR MANUFACTURING THE SAME

(75) Inventor: Seok-Hwan JEONG, Kawasaki (JP)

(73) Assignee: FUJITSU LIMITED, Kawasaki-shi (JP)

(21) Appl. No.: 12/882,020

(22) Filed: Sep. 14, 2010

(30) Foreign Application Priority Data
Sep. 15, 2009 (JP) 2009-213388

(51) Int. Cl. G02B 6/26

(52) U.S. Cl. 385/39; 264/1.25

(57) ABSTRACT

An optical element includes a first and a second layer in a first and a second region respectively in light propagating direction; a first and a second core layer above the first and the second layers respectively; a top layer above the first and the second core layer, the first and the second core layer extend in succession in the light propagating direction, a first projecting section exposes a side of the first core layer is in the first region, a second projecting section exposes at least part of a side of the second core layer is in the second region, a bottom section of the first projecting section is positioned below the bottom surface of the first core layer and the second core layer, and a bottom section of the second projecting section is positioned higher than the bottom section of the first projecting section.

### CROSS-REFERENCE TO RELATED APPLICATIONS

This application is based upon and claims the benefit of priority from the prior Japanese Patent Application No. 2009-213388 filed on Sep. 15, 2009, the entire contents of which are incorporated herein by reference.

### FIELD

The present invention relates to an optical semiconductor element and a method for manufacturing the same.

### BACKGROUND

A passive optical semiconductor element that includes a single-mode waveguide conducts optical signal processing such as splitting and coupling, in addition to transmitting optical signals, within an optical communication system.

Recently, active research has been conducted on optical signal transmission and modulation methods for increasing the amounts of signal transmission in optical communication systems. Optical signal transmission methods include wavelength multiplexing division. Optical modulation methods include quadrature phase shift keying (QPSK) and differential quadrature phase shift keying (DQPSK). When using such methods, it is important for a passive optical semiconductor element to be compact and high-density.

Waveguide structures included in passive optical semiconductor elements include high mesa structures. However, differences in refraction indexes of light in the lateral direction are larger than those in the height direction in waveguides with high mesa structures. Therefore, high-order transverse modes are easily excited. Furthermore, high-order transverse mode excitation due to mode shifting occurs easily because the radius of curvature of bent waveguides is smaller due to compactness and densification of passive optical semiconductor elements. When high-order transverse mode excitation occurs in waveguides in a passive optical semiconductor element, characteristics of optical function elements, especially optical splitting and coupling elements and elements using interferometers, may decrease greatly. Also, as passive optical semiconductor elements become smaller, characteristics deteriorate easily even when an excited high-order transverse mode propagates as a leaky mode.

Thus, it is desirable to remove the influence of high-order transverse modes for passive optical semiconductor elements that include high mesa structure waveguides. Accordingly, many studies are being conducted to remove the influence of high-order transverse modes in high mesa structure waveguides.

However, no effective technology has been established as of yet.

### SUMMARY

According to aspects of embodiments, an optical semiconductor element includes a first layer positioned in a first region in a light propagating direction; a second layer positioned in a second region in the light propagating direction; a first core layer formed above the first layer; a second core layer formed above the second layer; and a top layer formed above the first core layer and the second core layer, the first core layer and the second core layer extend in succession in the light propagating direction, a first projecting section that exposes a side of the first core layer is formed in the first region, a second projecting section that exposes at least part of a side of the second core layer is formed in the second region, a bottom section of the first projecting section is positioned below the bottom surface of the first core layer and the second core layer, and a bottom section of the second projecting section is positioned higher than the bottom section of the first projecting section.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B illustrate a structure of an optical semiconductor waveguide being studied;

FIGS. 2A to 2C illustrate simulation results;

FIGS. 3A to 3D illustrate a structure of an optical semiconductor element according to a first embodiment;

FIGS. 4A to 4C are cross-sectional views illustrating processes in manufacturing an optical semiconductor element according to the first embodiment;

FIGS. 5A to 5C are cross-sectional views illustrating processes in manufacturing an optical semiconductor element in a plane view illustrated in FIG. 3D;

FIGS. 6A and 6B illustrate the planar shape of a mask pattern 19;

FIGS. 7A and 7B illustrate simulation results;

FIGS. 8A to 8D illustrate a structure of an optical semiconductor element according to a second embodiment;

FIGS. 9A to 9C illustrate propagation characteristics of optical splitting and coupling elements that include various 4:4 MMI couplers;

FIGS. 10A to 10C illustrate results of simulations of the relation between wavelength and transmittance of optical splitting and coupling elements that include various 4:4 MMI couplers;

FIGS. 11A to 11C illustrate a structure of an optical semiconductor element according to a third embodiment; and

FIG. 12 illustrates a structure of an optical semiconductor device according to a fourth embodiment.

### DESCRIPTION OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present.

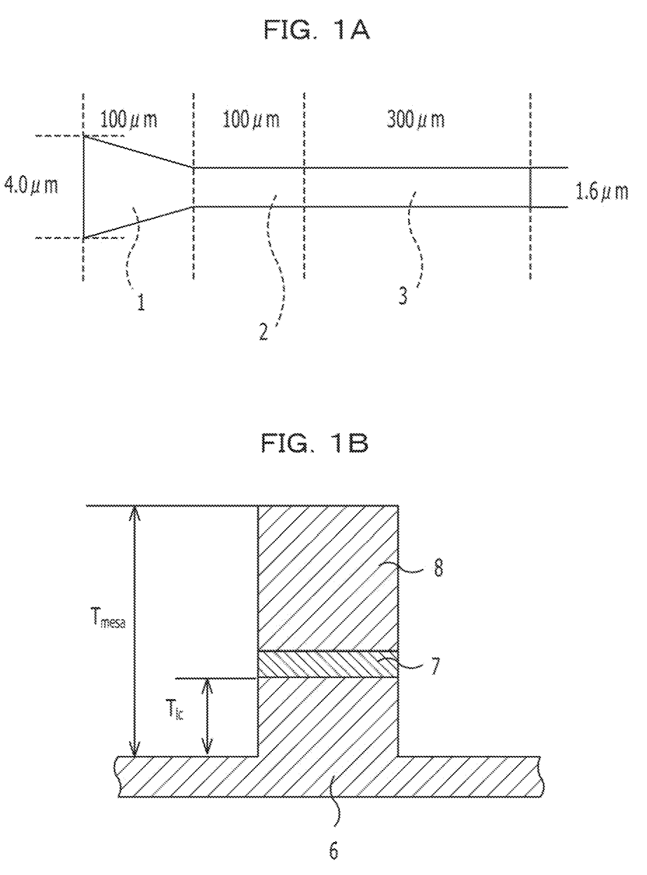

The inventor of the present invention conducted research on the relation between propagation characteristics and mesa height (mesa section height) of optical semiconductor waveguides with mesa structures. The following describes this research. In the research, the inventor used simulations to examine propagation characteristics of optical semiconductor waveguides made up of an input waveguide 1, a linear waveguide 2, and an output waveguide 3 coupled in order as illustrated in FIGS. 1A and 1B. FIG. 1A is a plane view of the structure of an optical semiconductor waveguide used in the research, and FIG. 1B is a cross-section view of an optical semiconductor waveguide used in the research.

As illustrated in FIG. 1A, in a planar shape an optical signal input part of the input waveguide 1 has a width of about 4.0 μm. The length of the input waveguide 1 is about 100 μm. A coupling part coupling the input waveguide 1 and the linear waveguide 2 has a width of about 1.6 μm. The width of the input waveguide 1 may become rectilinearly narrower approaching the coupling part of the linear waveguide 2. The width of the linear waveguide 2 is about 1.6 μm and the length of the linear waveguide 2 is about 100 μm. The width of the output waveguide 3 is about 1.6 μm and the length of the output waveguide 3 is about 300 μm.

On the other hand, the cross sections of the input waveguide 1, the linear waveguide 2, and the output waveguide 3 may be shared. Each of the waveguides includes a bottom cladding layer 6, a core layer 7 formed above the bottom cladding layer 6, and a top cladding layer 8 formed above the core layer 7. The core layer 7 is a GaInAsP layer with an bandgap wavelength λ_{g} of about 1.3 μm and a thickness of about 0.3 μm. The thickness of the top cladding layer 8 is about 2.0 μm. A mesa height Tₘₑₛₐ may be about 3.1 μm, 2.6 μm, or 2.3 μm. The height T_{lc} of a projecting part of the bottom cladding layer 6 may be about 0.8 μm, 0.3 μm or 0 μm. An optical semiconductor waveguide with this type of structure meets single mode conditions.

When several modes of an optical semiconductor waveguide are excited, distribution of the excited modes differs according to the shape of the optical semiconductor waveguide and the field distribution of the inputted light. A mode amplitude coefficient Cv (where “v” is the mode number) is illustrated in formula 1.

$${C}_{v} = \frac{{\int }_{- ∞}^{∞} Ψ ( y ) \cdot {φ}_{v} ( y ) d y}{\sqrt{{\int }_{- ∞}^{∞} {φ}_{v} ( y ) \cdot {φ}_{v}^{*} ( y ) d y}} \qquad ( Formula 1 )$$

Here, “ψ(y)” represents input field distribution, and “φᵥ(y)” represents each of the excited mode distributions of the optical semiconductor waveguide.

In the simulations, the input mode and the excited mode of the optical semiconductor waveguide were estimated to each have Gaussian distribution and sine wave distribution for calculating typical mode amplitude coefficients (C₀=0.6, C₁=0.3, C₂=0.1). The three input modes were excited and propagation characteristics were calculated with the 3-dimensional beam propagation method (BPM).

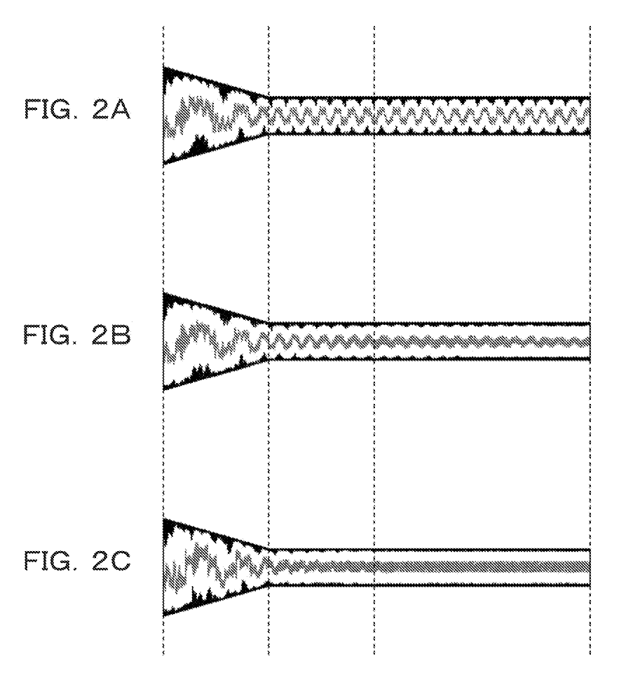

The results of the simulation are illustrated in FIGS. 2A to 2C. FIG. 2A illustrates propagation characteristics when the height T_{lc} is about 0.8 μm. FIG. 2B illustrates propagation characteristics when the height T_{lc} is about 0.3 μm. FIG. 2C illustrates propagation characteristics when the height T_{lc} is about 0 μm.

As illustrated in FIG. 2A, when the height T_{lc} is about 0.8 μm, the light wave propagates in a wavy line for several hundred μm. In other words, a high-order transverse mode propagates as a leaky mode.

However, as illustrated in FIG. 2B, when the height T_{lc} is about 0.3 μm, the waviness of the light is reduced. If the light propagates for about 400 μm, distribution becomes a 0th-order mode. This is because when the height T_{lc} is lower, the attenuation factor of the high-order transverse mode is increased.

When the height T_{lc} is about 0 μm, attenuation of the high-order leaky mode is further improved as illustrated in FIG. 2C. If the light propagates for about 100 μm, the high-order transverse mode is mostly attenuated.

As may be seen from the results of the simulations, the lower the height T_{lc} of the projecting part of the lower cladding layer 6 in a mesa structure optical semiconductor waveguide, the more the influence of the high-order transverse mode propagating as a leaky mode may be controlled.

Mesa structures include a high mesa structure, a ridge structure, and a rib structure. In the example illustrated in FIG. 1B, if the mesa height Tₘₑₛₐ is greater than 2.3 μm, the structure is a high mesa structure. If the mesa height Tₘₑₛₐ is greater than 2.0 μm and equal to or less than 2.3 μm, the structure is a ridge structure. If the mesa height Tₘₑₛₐ is about 2.0 μm or less, the structure is a rib structure. Thus, mesa structures may be divided into structures with the entire core layer 7 included in the mesa section, part of the core layer 7 included in the mesa section, or none of the core layer 7 included in the mesa section. The above simulations are applicable to high mesa structures. However, when considering the trends of the high mesa structure, attenuation of the high-order transverse mode that propagates as a leaky mode in a ridge structure is further improved, and the ridge structure is very effective in controlling the high-order transverse mode.

### First Embodiment

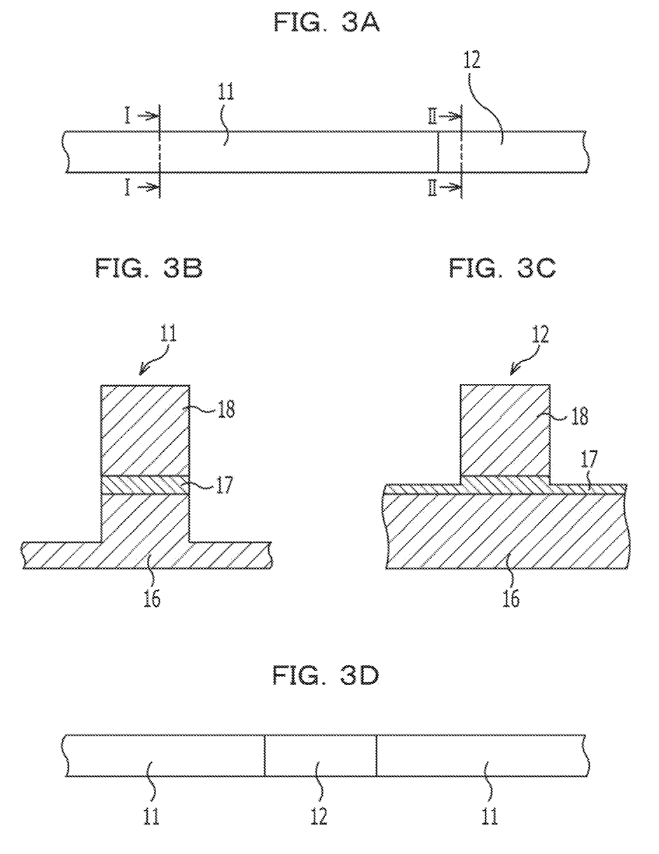

Next, a first embodiment will be described. FIGS. 3A to 3D illustrate a structure of an optical semiconductor element according to the first embodiment.

The optical semiconductor element according to the first embodiment is provided with a mesa section that has a width of, for example, about 1.6 μm and includes a first mesa region 11 and a second mesa region 12 that are coupled to each other in a plane view as illustrated in FIG. 3A. FIG. 3B is a cross-section at the line I-I in FIG. 3A, and FIG. 3C is a cross-section at the line II-II in FIG. 3A. Both the first mesa region 11 and the second mesa region 12 are formed with a bottom cladding layer 16, a core layer 17 above the bottom cladding layer 16, and a top cladding layer 18 above the core layer 17 as illustrated in FIGS. 3B and 3C. The configuration and thicknesses of the bottom cladding layer 16, the core layer 17, and the top cladding layer 18 may be substantially the same in the first mesa region 11 and the second mesa region 12. The positions of the bottom and top surfaces of the core layer 17 may also be substantially the same for the first mesa region 11 and the second mesa region 12.

The structure of the first mesa region 11 is a high mesa structure. The structure of the second mesa region 12 is a ridge structure. In other words, the top cladding layer 18, the core layer 17, and a part of the bottom cladding layer 16 are included in the mesa section of the first mesa region 11, whereas the top cladding layer 18 and a part of the core layer 17 are included in the mesa section of the second mesa region 12, but the bottom cladding layer 16 is not included in the mesa section of the second mesa region 12.

The bottom cladding layer 16 may be, for example, an n-type InP substrate or an undoped InP substrate. The core layer 17 may be an undoped GaInAsP layer for example. The core layer 17 may have the bandgap wavelength of about 1.3 μm and the thickness of about 0.3 μm, for example. The top cladding layer 18 may be, for example, a p-type InP layer or an undoped InP layer, and may have a thickness of about 2.0 μm. The height of the mesa section in the first mesa region 11 may be for example 2.7 to 3.2 μm. The height of the mesa section in the second mesa region 12 may be for example 2.0 to 2.5 μm.

The above thicknesses, widths, and bandgap wavelengths are not especially limited to the above figures, as long as desirable single mode conditions are met.

When a light signal is propagated from the first mesa region 11 toward the second mesa region 12 in the optical semiconductor element described above, a high-order transverse mode is attenuated in the second mesa region 12 even if a high-order transverse mode is generated in the first mesa region 11 or an earlier stage. When a light signal is propagated from the second mesa region 12 toward the first mesa region 11, a high-order transverse mode propagating in the first mesa region 11 is attenuated even if a light signal excited by the high-order transverse mode is inputted into the second mesa region 12. Thus, a high-order transverse mode light signal may be attenuated according to the first embodiment.

Also, by using the optical semiconductor element according to the first embodiment, limitations on radius of curvature and deterioration of optical splitting and coupling element characteristics may be avoided.

As illustrated in FIG. 3D, the second mesa region 12 may be provided between two first mesa regions 11. The length of the second mesa region 12 may be for example 100 μm. In this structure, if a high-order transverse mode is generated in one of the first mesa regions 11, the high-order transverse mode may be attenuated by the second mesa region 12 before propagating to the other first mesa region 11.

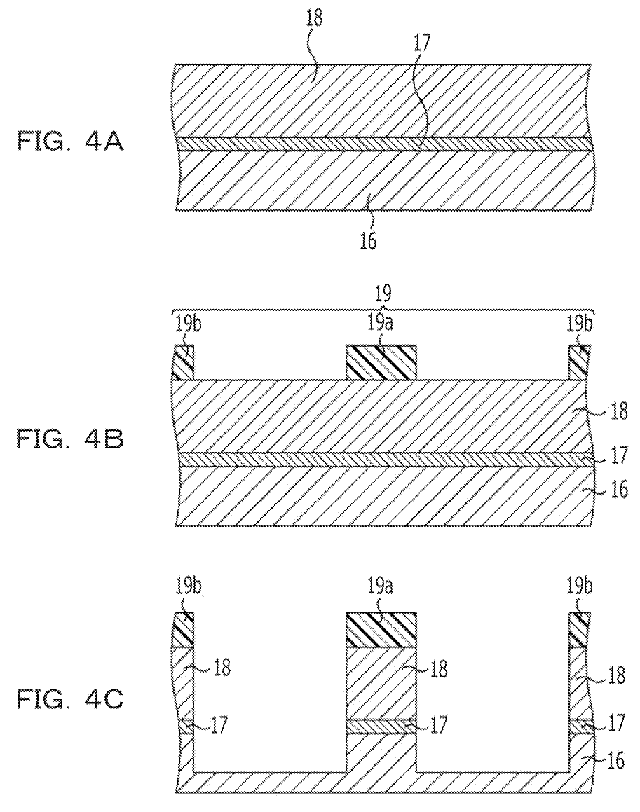

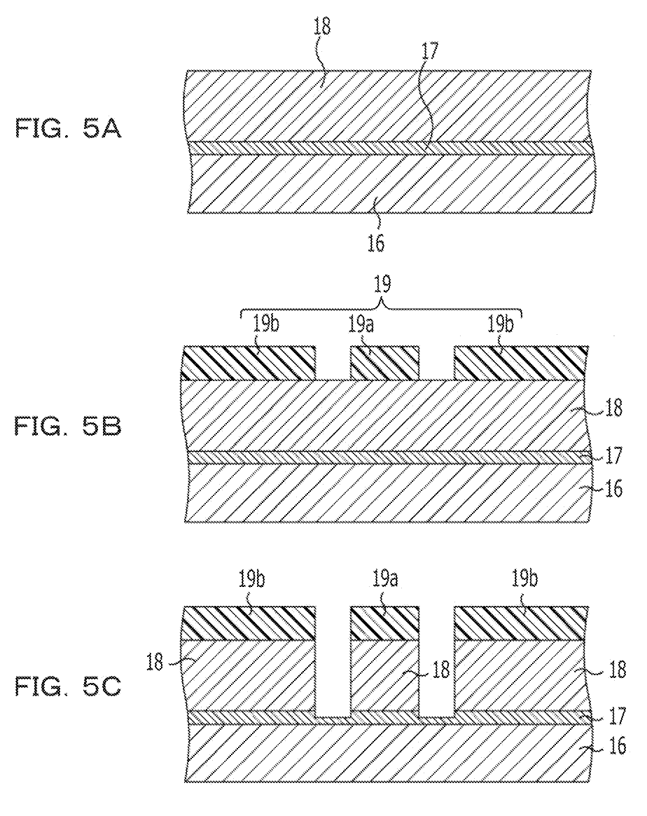

Next, a method for manufacturing the optical semiconductor element in the plane view illustrated in FIG. 3D will be described. FIGS. 4A to 4C and FIGS. 5A to 5C are cross-sections illustrating a process order for manufacturing the optical semiconductor element in the plane view illustrated in FIG. 3D. FIGS. 4A to 4C illustrate the section for forming the first mesa region 11, and FIGS. 5A to 5C illustrate the section for forming the second mesa region 12.

As illustrated in FIGS. 4A and 5A, the core layer 17 and the top cladding layer 18 are formed in order above the bottom cladding layer 16 that acts as a substrate using, for example, the metal organic vapor phase epitaxy (MOVPE) method. In other words, the core layer 17 and the top cladding layer 18 are epitaxially grown layers.

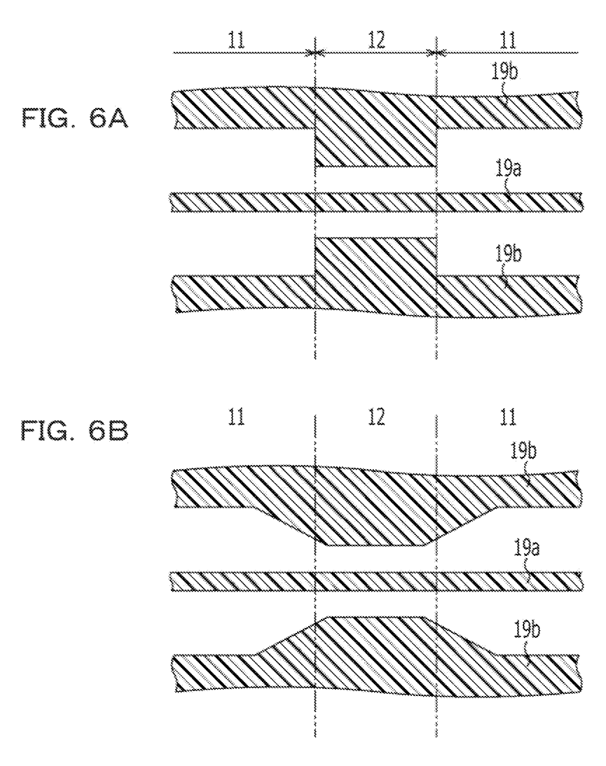

As illustrated in FIGS. 4B and 5B, a hard mask pattern 19 is formed above the top cladding layer 18. FIG. 6A illustrates a plane view of the mask pattern 19. The mask pattern 19 may have a mesa forming section 19a that corresponds to a section for forming the mesa section, and a mesa height adjustment section 19b, which is separated from the mesa forming section 19a, for adjusting mesa height. The width of the mesa forming section 19a of both the first mesa region 11 and the second mesa region 12 may be about 1.6 μm. However, the gap between the mesa forming section 19a and the mesa height adjustment section 19b may be narrower in the section forming the second mesa region 12 than in the section forming the first mesa region 11. For example, the gaps between the sections 19a and 19b in the section forming the second mesa region 12 may be about 0.5 to 1.5 μm (for example, 1.0 μm), and the gaps between the sections 19a and 19b in the section forming the first mesa region 11 may be about 5.0 to 15.0 μm (for example, 9.0 μm). The mask pattern 19 may be formed as follows. For example, an silicon dioxide film may be formed above the top cladding layer 18 by, for example, a vapor deposition method. A photoresist may be formed and patterned using a light exposure process. The patterned photoresist, which is a resist pattern, acts as a mask to process an inorganic film. In this way, the mask pattern 19 is formed as a hard mask.

After forming the mask pattern 19, the mask pattern 19 is used as a mask to process the top cladding layer 18, the core layer 17, and the bottom cladding layer 16 as illustrated in FIGS. 4C and 5C. This process may be conducted by dry etching such as inductively coupled plasma (ICP) reactive ion etching.

The etching speed in the section forming the second mesa region 12 is slower than the etching speed in the section forming the first mesa region 11 due to the effect of micro-loading because the gap between the mesa height adjustment section 19b and the mesa forming section 19a is narrow. Thus, when a groove in the section that forms the second mesa region 12 reaches the core layer 17, the groove in the section that forms the first mesa region 11 may reach the bottom cladding layer 16. Actually, when the inventor conducted ICP reactive dry etching in the same type of layered body as described above, where the gap between the sections 19a and 19b in the section forming the second mesa region 12 is about 1.0 μm and the gap between the sections 19a and 19b in the section forming the first mesa region 11 is about 9.0 μm, the depth of the groove (mesa height) in the section forming the second mesa region 12 was about 2.5 μm, and the depth of the groove (mesa height) in the section forming the first mesa region 11 was 3.2 μm. Thus the effect of micro-loading was about 0.7 μm.

The mask pattern 19 is removed after processing the top cladding layer 18, the core layer 17, and the bottom cladding layer 16. In this way, an optical semiconductor element may be manufactured.

When using the effect of micro-loading in dry etching, it is difficult to strictly control the amount of etching. In other words, it is difficult to strictly control the height of the mesa section of the second mesa region 12. However, in this embodiment, since there is no need to strictly control the height of the mesa section of the second mesa region 12, the lack of strict control may not be a problem. Since the effective refractive index that easily influences the characteristics of optical semiconductor elements is mostly determined with the first mesa region 11, even if the effective refractive index varies somewhat in the second mesa region 12, deterioration of the characteristics may be very small as long as the second mesa region 12 is able to attenuate excitation of the high-order transverse mode.

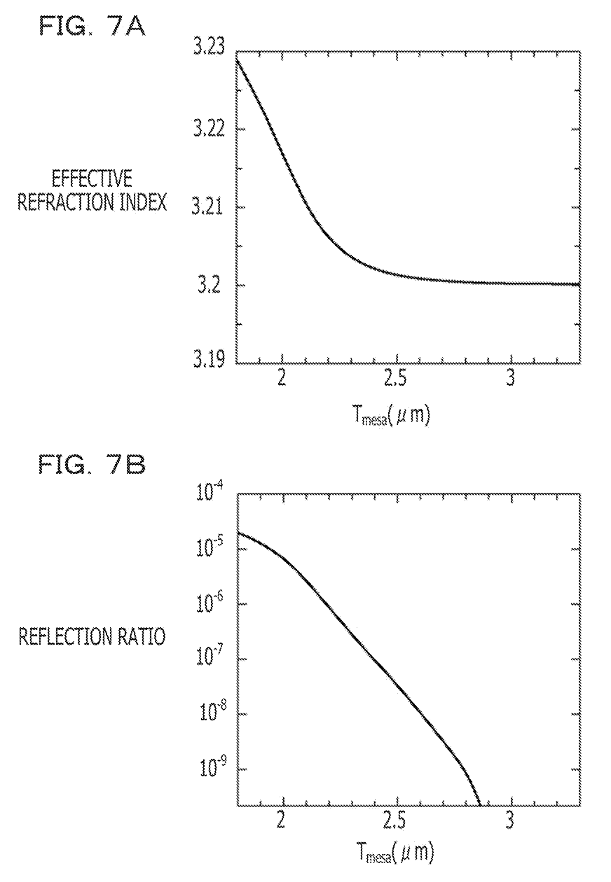

Here, simulations related to the first embodiment conducted by the inventor will be described. The simulations illustrates the relation between the effective refraction index of an entire optical semiconductor element and the mesa height Tₘₑₛₐ of the second mesa region 12 where the mesa height of the first mesa region 11 is fixed at about 3.2 μm. The simulations also illustrates the relation between the reflection ratio at the boundary between the first mesa region 11 and the second mesa region 12, and the mesa height Tₘₑₛₐ of the second mesa region 12. The results of the simulations are illustrated in FIGS. 7A and 7B.

As illustrated in FIG. 7A, when the mesa section of the second mesa region 12 is a rib structure (0<Tₘₑₛₐ≦2.0) or a ridge structure (2.0<Tₘₑₛₐ≦2.3), the higher the mesa height Tₘₑₛₐ, the lower the effective refraction index. However, variation of the effective refraction index of the entire optical semiconductor element is within 0.03.

Also, as illustrated in FIG. 7B, the lower the mesa height Tₘₑₛₐ, the higher the reflection ratio at the boundary between the first mesa 11 and the second mesa region 12. The reflection ratio is less than 10⁻⁵ when the mesa section of the second mesa region 12 is a ridge structure (2.0<Tₘₑₛₐ≦2.3).

Based on the results, it may be said that the influence toward reflection ratio and effective refraction index are small even when the mesa height Tₘₑₛₐ of the second mesa region 12 varies. Considering the FIGS. 1A and 1B and the results illustrated in FIGS. 2A to 2C, the size of the allowable range of the mesa height Tₘₑₛₐ of the second mesa region 12 may be about 0.8 μm or more. Thus, a high yield rate may be obtained based on the accuracy of the existing dry etching technology.

Using the manufacturing methods illustrated in FIGS. 4A to 4C and FIGS. 5A to 5C, the mesa height adjustment section 19b is provided in the section forming the first mesa region 11. However, the mesa height adjustment section 19b may not be provided in these sections since there is no need to reduce the speed of the dry etching with the effect of micro-loading.

As illustrated in FIG. 6B, a section that gradually slopes away from the edge of the section that forms the second mesa region 12 may be provided in the mesa height adjustment section 19b of the mask pattern 19. The length of the gradually sloping section may be about 50 μm to 100 μm if the length of the second mesa region 12 is around 100 μm. Even in this case, the mesa height of the second mesa region 12 may be lowered with the effect of micro-loading. Also, the reflection ratio at the boundary of the first mesa region 11 and the second mesa region 12 may be lower than when using the mask pattern 19 as illustrated in FIG. 6A because the change in the mesa height is gradual.

### Second Embodiment

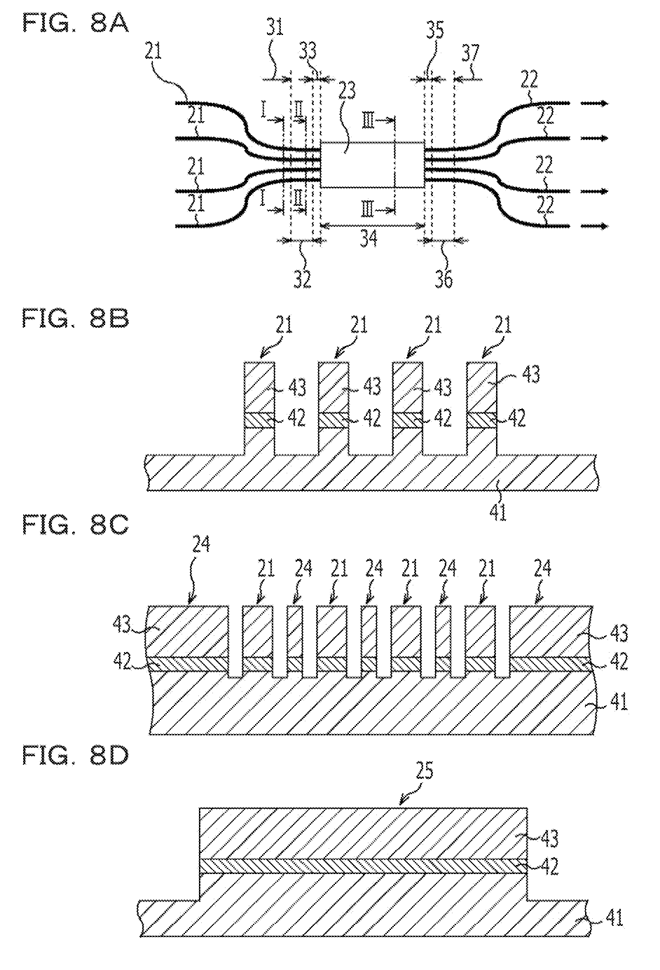

Next, a second embodiment will be described. FIGS. 8A to 8D illustrate a structure of the optical semiconductor element according to the second embodiment. FIG. 8B is a cross-section along the line I-I of FIG. 8A, FIG. 8C is a cross-section along the line II-II of the FIG. 8A, and FIG. 8D is a cross-section along the line III-III of the FIG. 8A.

The second embodiment is an optical splitting and coupling element made up of a 4:4 multimode interference (MMI) coupler 23. Four input waveguides 21 may be coupled to the input side of the coupler 23, and four output waveguides 22 may be coupled to the output side. Each of the input waveguides 21 may include a first mesa region 31, a second mesa region 32, and a first mesa region 33. The second mesa region 32 may be provided in between the first mesa region 31 and the first mesa region 33. The coupler 23 may include a first mesa region 34. Each of the output waveguides 22 may include a first mesa region 35, a second mesa region 36, and a first mesa region 37.

As illustrated in FIGS. 8B, 8C, and 8D, each of the first mesa region 31, the second mesa region 32, and the first mesa region 34 includes a bottom cladding layer 41 acting as a substrate, a core layer 42 formed above the bottom cladding layer 41, and a top cladding layer 43 formed above the core layer 42. The composition and the thicknesses of the bottom cladding layer 41, the core layer 42, and the top cladding layer 43 may be the same among the first mesa region 31, the second mesa region 32, and the first mesa region 34. The positions of the bottom surface and the top surface of the core layer 42 may also be the same among the first mesa region 31, the second mesa region 32, and the first mesa region 34. The mesa heights of the first mesa region 31 and the first mesa region 34 match, but the mesa height of the second mesa region 32 is lower than those of the first mesa regions 31 and 34.

As illustrated in FIG. 8B, there are no mesa sections in between the input waveguides 21 in the first mesa region 31. However, etching remainder sections 24 are provided between the input waveguides 21 in the second mesa region 32 as illustrated in FIG. 8C. The etching remainder sections 24 are provided for dry etching control using the micro-loading effect described above. However, light signals are not inputted or outputted here. Also, a branch coupling section 25 wider than the input waveguides 21 may be provided in the coupler 23 as illustrated in FIG. 8D.

The cross-sections of the mesa sections of the first mesa regions 33, 35, and 37 are similar to the cross-section of the mesa section of the first mesa region 31. The cross-section of the mesa section of the second mesa region 36 is similar to the cross-section of the mesa section of the second mesa region 32. The first mesa regions 31 and 37 may include bent waveguides.

In the second embodiment, a high-order transverse mode is attenuated in the second mesa region 32 even if a light signal propagating in the input waveguides 21 has a high-order transverse mode. Thus, the coupler 23 conducts appropriate optical coupling and splitting. Also, a high-order transverse mode is attenuated in the second mesa region 36 even if a high-order transverse mode is generated in the coupler 23.

In the second embodiment, the branch coupling section 25 in the coupler 23 corresponds to the first mesa region 34 and the mesa height is substantially the same as the mesa heights of the first mesa regions 31, 33, 35, and 37, and higher than the mesa heights of the second mesa regions 32 and 36. In this way, desirable characteristics of optical coupling and optical splitting are maintained.

Also, tapering of the widths of the input waveguides 21 (access waveguides) that are coupled to the branch coupling section 25 may be provided to reduce the wavelength dependence and the optical polarization dependence of the splitting and coupling characteristics. In other words, the input waveguides 21 may be provided with a part that gradually becomes more narrow from the input side to the output side as illustrated in FIG. 1A. Also, the input waveguides 21 may include a part that gradually becomes wider from the input side to the output side. In structures of the related art provided with a tapered width, there is a higher possibility of an excited high-order transverse mode as the width of the waveguide increases, which may cause the element characteristics to deteriorate greatly. However, in this embodiment, the high-order transverse mode is attenuated in the second mesa region 32 even if the high-order transverse mode is excited.

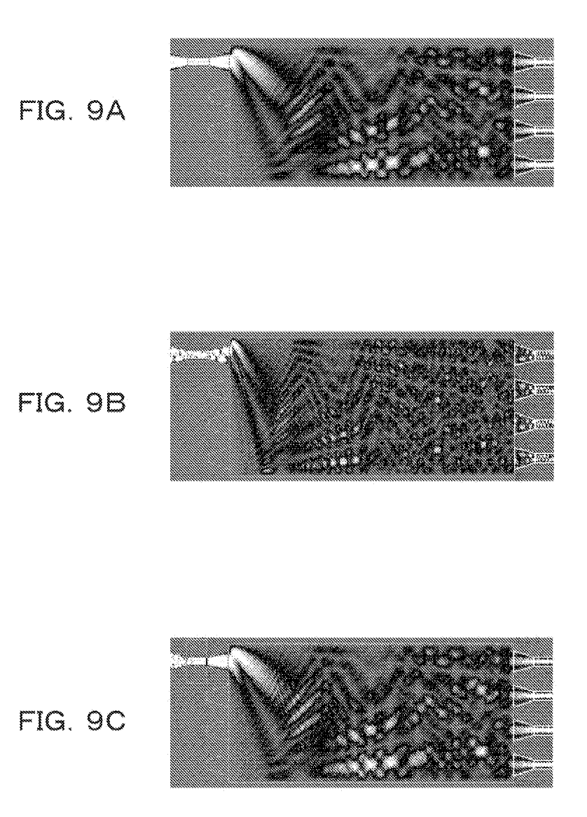

FIGS. 9A to 9C illustrate the result of propagation characteristic simulations on optical splitting and coupling elements including various 4:4 MMI couplers. FIG. 9A illustrates the propagation characteristics of an optical splitting and coupling element of the related art when inputted with a 0th-order mode (C₀=0.333) optical signal. FIG. 9B illustrates the propagation characteristics of an optical splitting and coupling element of the related art when inputted with a multimode (0th-order mode (C₀=0.333), first-order mode (C₁=0.333), and second-order mode (C₂=0.333)) optical signal. FIG. 9C illustrates the propagation characteristics of an optical splitting and coupling element of the second embodiment when inputted with a multimode (0th-order mode (C₀=0.333), first-order mode (C₁=0.333), and second-order mode (C₂=0.333)) optical signal. In these optical splitting and coupling elements, the input waveguides coupled to the 4:4 MMI coupler may be provided with two tapered sections and a linear section having a substantially constant width between the two tapered sections. The length of the tapered section at the input side may be about 100 μm, and the width may narrow rectilinearly from about 4.0 μm to 1.6 μm. The length of the linear section is about 100 μm and the width is about 1.6 μm. The length of the tapered section at the output side (4:4 MMI coupler side) may be about 100 μm, and the width may increase rectilinearly from about 1.6 μm to 4.0 μm. The tapered section at the output side may be coupled to an input port of the 4:4 MMI coupler. The gap between each of the four input ports of the 4:4 MMI coupler is about 2.0 μm, and the length of the 4:4 MMI coupler waveguides is about 1.2 mm.

As illustrated in FIG. 9A, when only a 0th-order mode optical signal is inputted, excitation of the high-order transverse mode does not happen and the inputted optical signal may be evenly divided into four output channels of an optical splitting and coupling element of the related art. However, when a multimode optical signal is inputted into the optical splitting and coupling element of the related art, the optical signals are not branched equally because the high-order transverse mode propagates as a leaky mode in the input waveguide (see FIG. 2A) as illustrated in FIG. 9B. In other words, the mode interference actions inside the 4:4 MMI coupler disagree and the excitation of the high-order transverse mode continues. Accordingly, splitting and coupling characteristics deteriorate. However, even when a multimode optical signal is inputted into the optical splitting and coupling element of the second embodiment, the high-order transverse mode excitation is attenuated in the input waveguides (see FIGS. 2B and 2C), and the optical signal that is inputted into the 4:4 MMI coupler is mostly a 0th-order mode optical signal. Thus, the optical signals are divided into four branches as illustrated in FIG. 9C. In this way according to the second embodiment, the high-order transverse mode propagating as a leaky mode may be attenuated and the optical signal may be branched appropriately.

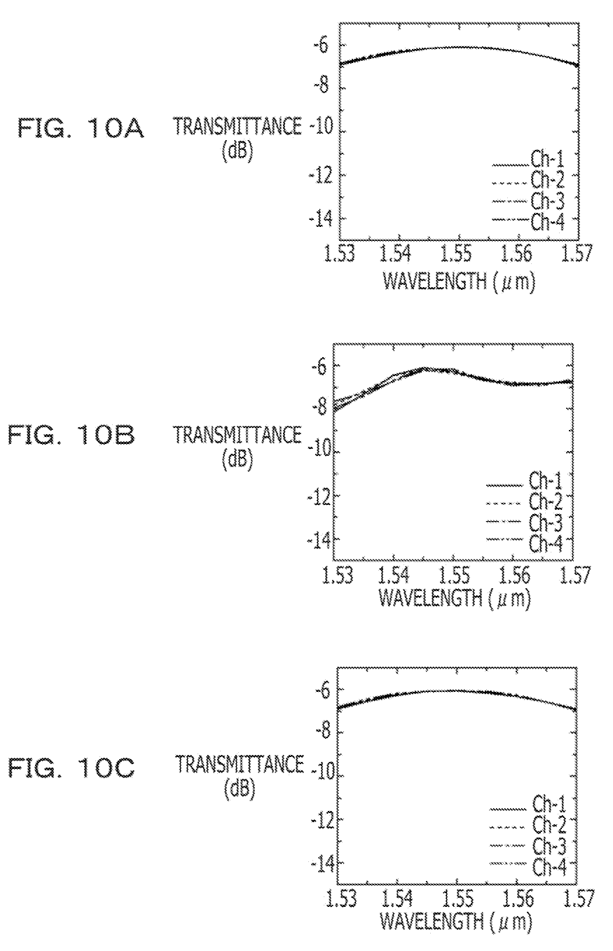

FIGS. 10A to 10C illustrate results of simulations of the relation between wavelength and transmittance in optical splitting and coupling elements that include various 4:4 MMI couplers. The 4:4 MMI coupler construction and the input optical signal used in the simulations illustrated in FIGS. 10A, 10B, and 10C are substantially the same as those of FIGS. 9A, 9B, and 9C.

As illustrated in FIG. 10A, since there is no high-order transverse mode influence even in an optical splitting and coupling element of the related art when only a 0th-order mode optical signal is inputted, the wavelength dependence within the C-band is about 0.9 dB. However, when a multimode optical signal is inputted into an optical splitting and coupling element of the related art, the C-band wavelength dependence increases to about 2.0 dB. The wavelength spectra also has an uneven shape. Moreover, there is a noticeable deviation between channels (Ch-1, Ch-2, Ch-3, Ch-4). The amount of deterioration of the within characteristics due to the high-order transverse mode depends the mode amplitude coefficient Cv, and if the mode amplitude coefficient Cv of the high-order transverse mode increases, the wavelength dependence and the deviation between channels may further increase. However, in the optical within and coupling element according to the second embodiment, the wavelength spectral characteristics are substantially the same as illustrated in FIG. 10A even if a multimode optical signal is inputted.

In this way, the wavelength dependence and the deviation between channels of an optical splitting and coupling element according to the second embodiment may be stabilized regardless of the mode amplitude coefficient Cv of the high-order transverse mode. Furthermore, since the optical semiconductor element according to the second embodiment is manufactured using substantially the same method as in the first embodiment, a wide mesa height tolerance may be assured for the second mesa regions 32 and 36. Thus, the optical semiconductor element may be manufactured with a high yield rate. The cross-section structure of the second mesa regions 32 and 36 in the second embodiment may be a ridge structure. Also, in the first embodiment, the second mesa region 12 may be a high mesa structure as long as the mesa height of the second mesa region 12 is lower than the mesa height of the first mesa region 11.

### Third Embodiment

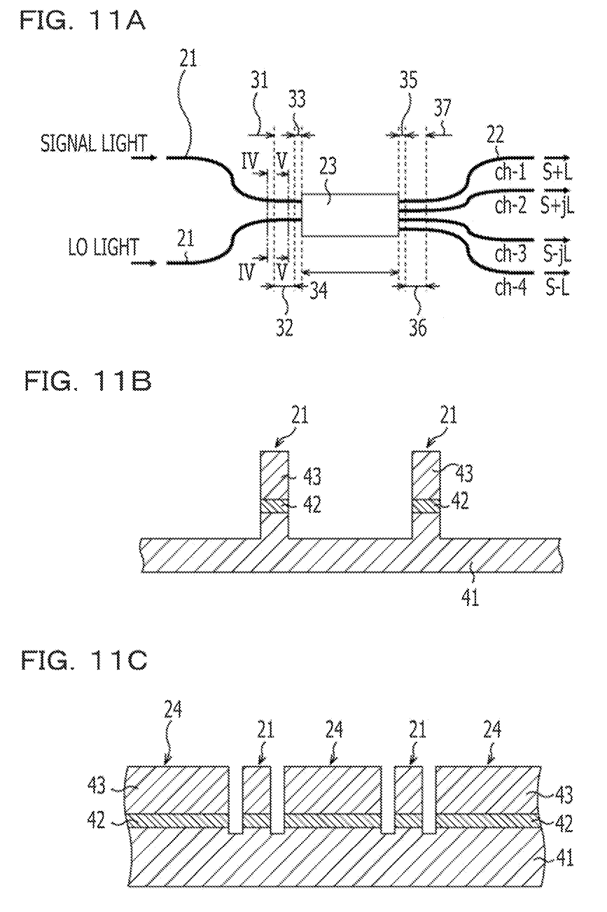

A third embodiment will be described below. FIGS. 11A to 11C illustrate an optical semiconductor element structure according to the third embodiment. FIG. 11B is a cross-section along the line IV-IV in FIG. 11A. FIG. 11C is a cross-section along the line V-V in FIG. 11A.

In the third embodiment, there are two input waveguides 21. The third embodiment differs from the second embodiment in that the input waveguides 21 are asymmetrically coupled to input ports of the coupler 23. Other configurations are substantially the same as the second embodiment. The two input waveguides 21 may be coupled to the input ports that are positioned asymmetrically with reference to the center of the coupler 23 in the width direction. The number of input ports is not limited. For example, two of four input ports may be coupled to the input waveguides 21.

The third embodiment configured as described above may function as a 90-degree hybrid optical circuit. In other words, one of the input waveguides 21 may input quadrature phase shift keying (QPSK) signal light, and the other input waveguide 21 may input local oscillator (LO) light. Based on the temporal synchronization of the inputs, different signals may be output in response to the relative phase difference Δφ of the QPSK signal light and the LO light. When the phase of the channel ch-1 signal (S+L) is 0, the channel ch-2 signal (S+jL) is −π/2, the channel ch-3 signal (S−jL) is +π/2, and the channel ch-4 signal (S−L) is π.

As in the second embodiment, the third embodiment may reduce the influence of the high-order transverse mode propagating as a leaky mode. Thus, the operating bandwidth (wavelength dependence) of the 90-degree hybrid operation and the relative phase deviation may be suppressed. Furthermore, since the mesa height may be easily controlled, the optical semiconductor element according to the third embodiment can be manufactured with a high yield rate.

Differential quadrature phase shift keying (DQPSK) light may be used in place of QPSK signal light.

### Fourth Embodiment

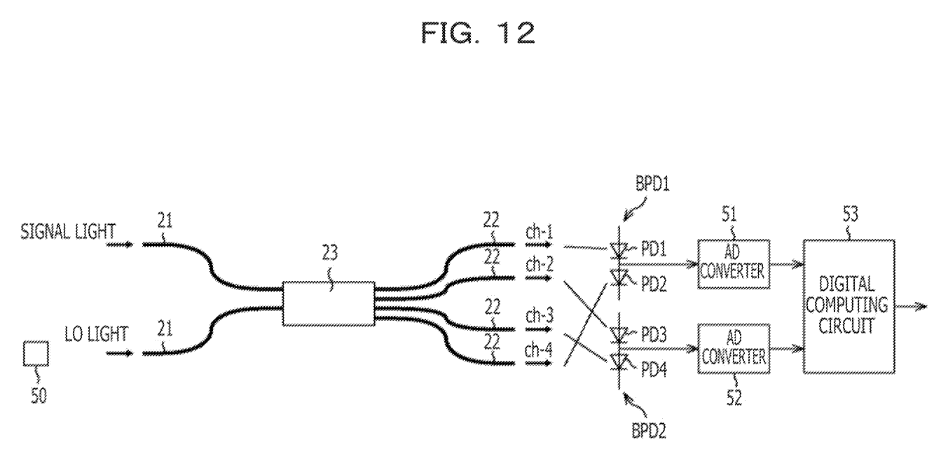

Next, a fourth embodiment will be described as follows. FIG. 12 illustrates a structure of an optical semiconductor device according to the fourth embodiment.

The optical semiconductor device according to the fourth embodiment may include the optical semiconductor element (90-degree hybrid optical circuit) according to the third embodiment, a LO light source, a balanced photodiode (BPD), an analog-to-digital (AD) converter, and a digital signal processing circuit. One of the input waveguides 21 on the input side of the 90-degree hybrid optical circuit of the third embodiment may be provided with a LO light source 50 that inputs LO light. Also a BPD 1 that receives a channel signal that has an in-phase relation and a BPD 2 that receives a channel signal having a quadrature phase relation may be provided on the output side of the 90-degree hybrid optical circuit of the third embodiment. The BPD 1 may include a photodiode (PD) 1 that receives a channel ch-1 signal and a PD 2 that receives a channel ch-4 signal. The BPD 2 may include a photodiode (PD) 3 that receives a channel ch-2 signal and a PD 4 that receives a channel ch-3 signal. The PD 1 and PD 2 are coupled to each other in series. An AD converter 51 that receives the electrical potential from the cathode of the PD 1 and from the anode of the PD 2 may be provided. The PD 3 and PD 4 are coupled to each other in series. An AD converter 52 that receives the electrical potential from the cathode of the PD 3 and from the anode of the PD 4 may be provided. Also, a digital computing circuit 53 that processes digital signals outputted by the AD converters 51 and 52 may be provided.

The fourth embodiment configured in this way may function as a coherent optical receiver (optical semiconductor device). In other words, when a LO signal temporally synchronized with a QSPK signal inputted into one of the input waveguides 21 is inputted into another input waveguide 21, different signals may be outputted based on the relative phase difference Δφ of the QPSK signal light and the LO light. In the fourth embodiment, channel signals that have in-phase and quardrature-phase phase relations are inputted into the BPD 1 and BPD 2 respectively connected in series. When the relative phase difference Δφ is (a) 0, (b) π, (c) −π/2, and (d)+π/2, the 90-degree hybrid output intensity ratio becomes (a) 1:0:2:1, (b) 1:2:0:1, (c) 0:1:1:2, and (d) 2:1:1:0. Therefore, the BPD 1 and BPD 2 input conditions also differ. When the PD 1 or PD 2 only receives optical signals in the BPD 1, an electrical current corresponding to 1 or −1 is applied. When the PD 1 and PD 2 both receive optical signals, no electrical current is applied. When the PD 3 or PD 4 only receives optical signals in BPD 2, an electrical current corresponding to 1 or −1 is applied. When the PD 3 and PD 4 both receive optical signals, no electrical current is applied. Thus, in the fourth embodiment, phase information of QPSK signal light may be identified, and the signal light may be converted into the electrical signal. An analog signal obtained by optoelectronic conversion is converted to a digital signal by the AD converter 51 and/or 52, and the digital computing circuit 53 processes the digital signal. In this way, the optical semiconductor device according to the fourth embodiment functions as a coherent optical receiver.

When the influence of the high-order transverse mode propagating in an optical waveguide as a leaky mode is large in a coherent optical receiver, the 90-degree hybrid output intensity ratio becomes disordered and cross-talk is generated which greatly reduces receiver sensitivity and the operating bandwidth. However, in the fourth embodiment, the output intensity ratio corresponding to the relative phase difference Δφ is stabilized because the high-order transverse mode may be attenuated. Thus, desirable receiving sensitivity and operating bandwidth may be achieved.

An N:N MMI coupler (where N is a natural number) may be used in place of the coupler 23 used in the embodiments. For example, a 1:N MMI coupler or a 2:N MMI coupler may be used. Also, a directional coupler, a Y-branch coupler, or a mode converter coupler may be used as couplers. Use of these types of couplers may achieve substantially the same effects as using the coupler 23.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An optical semiconductor element comprising:
a first layer positioned in a first region in a light propagating direction;
a second layer positioned in a second region in the light propagating direction;
a first core layer formed above the first layer;
a second core layer formed above the second layer; and
a top layer formed above the first core layer and the second core layer, wherein
the first core layer and the second core layer extend in succession in the light propagating direction,
a first projecting section that exposes a side of the first core layer is formed in the first region,
a second projecting section that exposes at least part of a side of the second core layer is formed in the second region,
a bottom section of the first projecting section is positioned below the bottom surface of the first core layer and the second core layer, and
a bottom section of the second projecting section is positioned higher than the bottom section of the first projecting section.

2. The optical semiconductor element according to claim 1, wherein:
the bottom section of the second projecting section is positioned higher than the bottom surface of the first core layer and the second core layer.

3. The optical semiconductor element according to claim 1, further comprising:
a third layer positioned in a third region, the second region being arranged between the third region and the first region in the light propagating direction; and
a third core layer formed above the third layer,
wherein the top layer is formed above the third core layer,
the third core layer extends in succession with the second core layer in the light propagating direction,
a third projecting section that exposes a side of the third core layer is formed in the third region, and
a bottom section of the third projecting section is positioned below the bottom section of the second projecting section.

4. The optical semiconductor element according to claim 1, further comprising:
at least one input waveguide, each including the first region and the second region;
a multimode interference waveguide coupled to the at least one input waveguide, the multimode interference waveguide includes,
a third layer positioned in a third region, the second region being arranged between the third region and the first region in the light propagating direction,
a third core layer formed above the third layer, with the top cladding layer formed above the third core layer,
a third projecting section that exposes a side of the third core layer is formed in the multimode interference waveguide, and
the bottom section of the third projecting section is positioned below the bottom section of the second projecting section.

5. The optical semiconductor element according to claim 4, wherein:
the at least one input waveguide includes multiple input waveguides; and
the third core layer couples all of the second core layers included in the at least one input waveguide.

6. The optical semiconductor element according to claim 4, wherein:
at least one input waveguide has a section that becomes wider close to the multimode interference waveguide.

7. The optical semiconductor element according to claim 4, wherein:
the optical semiconductor element is an optical splitting and coupling element.

8. The optical semiconductor element according to claim 1, further comprising:
two input waveguides, each including the first region and the second region;
a multimode interference waveguide coupled to the two input waveguides, the multimode interference waveguide includes,
a third layer positioned in a third region, the second region being arranged between the third region and the first region in the light propagating direction, and
a third core layer formed above the third layer, with the top layer formed above the third core layer,
the third core layer is coupled to all the second core layers included in the two input waveguides,
a third projection section that exposes a side of the third core layer is formed in the multimode interference waveguide,
the bottom section of the third projecting section is positioned lower than the bottom section of the second projecting section, and
the two input waveguides are positioned asymmetrically with reference to the center position in the width direction of the multimode interference waveguide.

9. The optical semiconductor element according to claim 8, wherein
one of the two input waveguides receives one of a quadrature phase shift keying signal light and a differential quadrature phase shift keying signal light, and
the multimode interference waveguide converts the one of the quadrature phase shift keying signal light and the differential quadrature phase shift keying signal light into a pair of optical signals that has an in-phase relation and an quadrature-phase relation.

10. An optical receiver comprising:
an optical semiconductor element;
a photodiode that converts a light signal outputted from the optical semiconductor element into an analog electric signal;
the optical semiconductor element includes,
two input waveguides,
a multimode interference waveguide coupled to the two input waveguides, and
four output waveguides coupled to the multimode interference waveguide;
each of the input waveguides and the output waveguides include:
a first layer positioned in a first region in a light propagating direction,
a second layer positioned in a second region in the light propagating direction,
a first core layer formed above the first layer,
a second core layer formed above the second layer,
a top layer formed above the first core layer and the second core layer,
the first core layer and the second core layer extend in succession in the light propagating direction,
a first projecting section that exposes a side of the first core layer is formed in the first region,
a second projecting section that exposes at least a part of a side of the second core layer and is formed in the second region,
a bottom section of the first projecting section is positioned below the bottom surface of the first core layer and the second core layer, and
the bottom section of the second projecting section is positioned higher than the bottom surface of the first projecting section,
the multimode interference waveguide includes,
a third layer positioned in a third region, the second region being arranged between the third region and the first region in the light propagating direction,
a third core layer that is formed above the third layer, with the top cladding layer formed above the third core layer,
the third core layer couples all the second core layers included in the two input waveguides,
a third projecting section that exposes a side of the third core layer is formed in the multimode interference waveguide,
the bottom of the third projecting section is positioned below the bottom section of the second projecting section; and
the two input waveguides are positioned asymmetrically with reference to the center position of the multimode interference waveguide in the width direction.

11. The optical receiver according to claim 10, further comprising:
an analog-to-digital converter that converts the analog electric signal outputted from the photodiode into a digital electric signal; and
a computing unit that computes the digital electric signal outputted from the analog-to-digital converter.

12. A method for manufacturing an optical semiconductor element, comprising:
forming a second semiconductor layer above a first semiconductor layer;
forming a third semiconductor layer above the second semiconductor layer;
forming a hard mask above the third semiconductor layer;
performing dry etching of the first semiconductor layer, the second semiconductor layer, and the third semiconductor layer using the hard mask;
the hard mask including
a first section that has a linear shape in a plane view,
a second section that is positioned on both sides of the first section and is separated from the first section,
wherein the second section has at least two regions that have different distances away from the first section.
